(19) United States
(12) Patent Application Publication
(10) Pub. No.: US 2015/0205444 A1
(43) Pub. Date: Jul. 23, 2015

(54) INTERACTIVE INPUT SYSTEM

(71) Applicant: SMART Technologies ULC, Calgary (CA)

(72) Inventor: DAVIN J. GALBRAITH, Calgary (CA)

(21) Appl. No.: 14/158,078

(22) Filed: Jan. 17, 2014

(51) Int. Cl. G06F 3/042; G06F 3/0354

(52) U.S. Cl. CPC G06F 3/0425; G06F 3/03547

(57) ABSTRACT

An interactive input system comprises an interactive board configured to generate positional output in response to a pointer contact with an input surface thereof. An interactive projector is configured to project an image on the input surface and to capture image frames of a region of interest at least comprising the input surface. Processing structure is configured to process positional output generated by the interactive board and image data acquired by the interactive projector to determine passive and active pointer contacts on the input surface.

The present invention relates to an interactive input system.

### BACKGROUND

Interactive boards such as for example digitizers and analog resistive touch screens or panels that make use of one or more electrically resistive membranes, are known in the art. Analog resistive touch panels of this nature typically include an electrically resistive membrane that is positioned over and spaced from an electrically resistive substrate. Small spacers at spaced locations help to maintain the gap between the electrically resistive membrane and the electrically resistive substrate. When a pointer such as a finger, pen tool, stylus or other suitable object is used to contact and apply pressure to the electrically resistive membrane with sufficient activation force, the electrically resistive membrane deflects and contacts the electrically resistive substrate thereby to make an electrical contact between the electrically resistive membrane and substrate. Determining voltage changes induced by the electrical contact allows the position of pointer contact on the touch panel in X-Y coordinates to be determined.

Many designs for analog resistive touch panels have been considered. For example, U.S. Pat. No. 5,838,309 to Robsky et al. discloses a self-tensioning membrane touch screen that avoids the need for insulating spacer dots. The touch screen includes a support structure having a base and a substrate support on which a conductive surface is disposed. A peripheral insulating rail surrounds the conductive surface. A peripheral flexible wall extends upwardly from the base. A conductive membrane is stretched over the conductive surface and is attached to the peripheral flexible wall. The insulating rail acts to space the conductive membrane from the conductive surface. To inhibit sagging and maintain tension on the conductive membrane, once the conductive membrane has been attached to the flexible wall, the flexible wall is biased outwardly and downwardly. As a result, tension is continuously applied to the conductive membrane by the flexible wall thereby to inhibit sagging of the conductive membrane.

U.S. Pat. No. 6,034,335 to Aufderheide et al. discloses an analog touch screen, comprising a top transparent layer disposed over a bottom transparent layer. The top layer comprises a flexible sheet having a layer of a semiconductive ceramic coated on a lower face thereof. The bottom transparent layer comprises a substrate sheet having a thin layer of a semiconductive ceramic coated on an upper face thereof. A non-electrically conductive spacer is interposed between the top and bottom layers effective for spacing apart the layers of semiconductive ceramic except when the top layer is flexed by an external touch so that electrical contact occurs between the semiconductive ceramic coatings on the layers at a location where the touch occurred. A noncontinuous, electrically conductive metallic film which in use does not form an appreciable amount of an insulating oxide covers at least one of the semiconductive ceramic coatings so that the film is interposed between the semiconductive ceramic coatings during electrical contact caused by a touch. The metallic film is of a thickness effective to reduce the effects of repeated operation on contact resistance over many operating cycles of the touch screen without substantially varying the sheet resistance of the underlying semiconductive ceramic coatings. Conductors are connected to the top and bottom layers for applying an electrical current to the semiconductive coats to determine the horizontal and vertical position of the external touch on the top layer.

U.S. Pat. No. 6,246,394 to Kalthoff et al. discloses a touch screen digitizing system that includes a touch screen unit including a first resistive sheet with opposed x+ and x− terminals and a second resistive sheet with opposed y+ and y− terminals and an analog to digital converter (ADC) having first and second reference input terminals. A first switch is coupled between a first reference voltage and the x− terminal and a second switch is coupled between the x+ terminal and a second reference voltage for energizing the first resistive sheet. A third switch is coupled between the first reference voltage and the y− terminal and a fourth switch is coupled between the y+ terminal and the second reference voltage for energizing the second resistive sheet. Switching circuitry couples an input of the ADC to the y+ terminal while the first resistive sheet is energized and the second resistive sheet is not energized and also couples the input to the x+ terminal while the second resistive sheet is energized and the first resistive sheet is not energized.

U.S. Pat. No. 6,664,950 to Blanchard discloses a resistive touch panel having a removable, top plate and a base plate. The touch panel may be situated relative to a display screen such that an air gap exists between the base plate and the display screen. The top plate includes a transparent, flexible substrate having a hard transparent coating, one or more anti-reflective coatings and an anti-fingerprint coating thereon. The underside of the substrate is spaced from the upper surface of the base plate by an air gap. To prevent wrinkling of the top plate, a stiff frame is bonded to the anti-fingerprint coating. The stiff frame maintains tension in the top plate despite temperature changes.

Although these analog resistive touch panels work satisfactory, their designs only permit a single pointer contact to be reported at any given time. It is therefore an object of the present invention to provide a novel interactive input system.

### SUMMARY

Accordingly, in one aspect there is provided an interactive input system comprising an interactive board configured to generate positional output in response to pointer contact with an input surface thereof; an interactive projector configured to project an image on said input surface and to capture image frames of a region of interest at least comprising said input surface; and processing structure configured to process positional output generated by said interactive board and image data acquired by said interactive projector to determine passive and active pointer contacts on said input surface.

In one embodiment, the processing structure determines passive pointer contact on the input surface when the interactive board generates positional output and captured image frames are devoid of an active pointer and determines active pointer contact on the input surface when the interactive board generates positional output and captured image frames comprise an active pointer.

In one embodiment, the processing structure is further configured to process captured image frames and generate positional output when an active pointer exists therein and compare the positional output with the positional output generated by the interactive board to differentiate between passive and active pointer contact on the input surface. The positional output generated by the processing structure and the positional output generated by the interactive board may comprise X-Y coordinate streams. In this case, the processing structure compares the X-Y coordinate streams to determine if X-Y coordinates of the X-Y coordinate streams are generally coincident and if so, determines active pointer contact with the input surface. If X-Y coordinates of the X-Y coordinate streams are not generally coincident, the processing structure determines both active and passive pointer contacts the said input surface. The processing structure, when both active and passive pointer contacts with the input surface are determined, processes the X-Y coordinate streams to determine the X-Y coordinates of the active and passive pointer contacts.

In one embodiment, the processing structure may comprise at least one processor of the interactive projector, with the at least one processor processing captured image frames to determine the existence of an active pointer therein and the position of the active pointer in X-Y coordinates relative to the input surface. The processing structure may further comprise at least one processor of a control module with the at least one processor of the control module comparing the X-Y coordinate streams from the interactive board and interactive projector to determine if X-Y coordinates of the X-Y coordinate streams are generally coincident and if so, determine active pointer contact with the input surface. If X-Y coordinates of the X-Y coordinate streams are not generally coincident, the at least one processor of the control module determines both active and passive pointer contacts with the input surface. The at least one processor of the control module, when both active and passive pointer contacts with the input surface are determined, processes the X-Y coordinate streams to determine the X-Y coordinates of the active and passive pointer contacts.

In one embodiment, the processing structure may further comprise a general purpose computing device. The general purpose computing device receives the X-Y coordinate streams from the interactive board and interactive projector, compares the X-Y coordinate streams to determine if X-Y coordinates of the X-Y coordinate streams are generally coincident and if so, determines active pointer contact with the input surface. If X-Y coordinates of the X-Y coordinate streams are not generally coincident, the general purpose computing device determines both active and passive pointer contacts with the input surface. The general purpose computing device, when both active and passive pointer contacts with the input surface are determined, processes the X-Y coordinate streams to determine the X-Y coordinates of the active and passive pointer contacts.

In one embodiment, the processing structure provides image data to the interactive projector that is used by the interactive projector to project the image. The image may be for example a computer desktop. The processing structure updates the image data provided to the interactive projector in response to determined passive and active pointer contacts.

According to another aspect there is provided a method comprising receiving, by processing structure, at least one of an X-Y coordinate stream from an interactive board and an X-Y coordinate stream from an interactive projector; when X-Y coordinate streams are received from both the interactive board and interactive projector, comparing, by the processing structure, the X-Y coordinate streams to determine if the X-Y coordinates thereof are generally coincident; when the X-Y coordinates are generally coincident, determining, by the processing structure, that an active pointer contact with an input surface of the interactive board has been made; and when the X-Y coordinates are not generally coincident, determining, by the processing structure, that both passive and active pointer contacts with the input surface have been made.

In one embodiment, an event for each determined pointer contact is generated. Each event may be one of a write event and a mouse event. An image projected on the input surface may be updated in response to generated events.

According to another aspect there is provided a non-transitory computer readable medium embodying program instructions, which when executed by processing structure, cause the processing structure to carry out the above method.

### BRIEF DESCRIPTION OF THE DRAWINGS

Embodiments will now be described more fully with reference to the accompanying drawings in which:

FIG. 1 is a perspective view of an interactive input system comprising an interactive board, an interactive projector, a projector control module and a general purpose computing device;

FIG. 2a is a schematic diagram of the interactive projector;

FIG. 2b is a schematic diagram of an active pen tool;

FIG. 3 is a front view showing circuitry components of the interactive board;

FIG. 4 is a cross-sectional view of FIG. 3 taken along line 4-4;

FIG. 5 is a schematic illustration of a top layer of the interactive board;

FIG. 6 is a schematic illustration of a bottom layer of the interactive board;

FIG. 7 is a schematic illustration, partly in section, of the interactive board;

FIG. 8 is a schematic diagram of the projector control module;

FIG. 9 is a perspective view of the interactive input system of FIG. 1 showing a user's finger brought into contact with the interactive board;

FIG. 10 is a perspective view of the interactive input system of FIG. 1 showing an active pen tool brought into contact with the interactive board;

FIG. 11 is a perspective view of the interactive input system of FIG. 1 showing both a user's finger and an active pen tool brought into contact with the interactive board;

FIG. 12 is a perspective view of another embodiment of an interactive input system comprising an interactive board, an interactive projector and a general purpose computing device;

FIG. 13 is a perspective view of another embodiment of an interactive input system comprising an interactive board, an interactive projector and a general purpose computing device; and

FIG. 14 is a perspective view of another embodiment of an interactive input system comprising an interactive board, an interactive projector, a projector control module and a general purpose computing device.

### DETAILED DESCRIPTION OF THE EMBODIMENTS

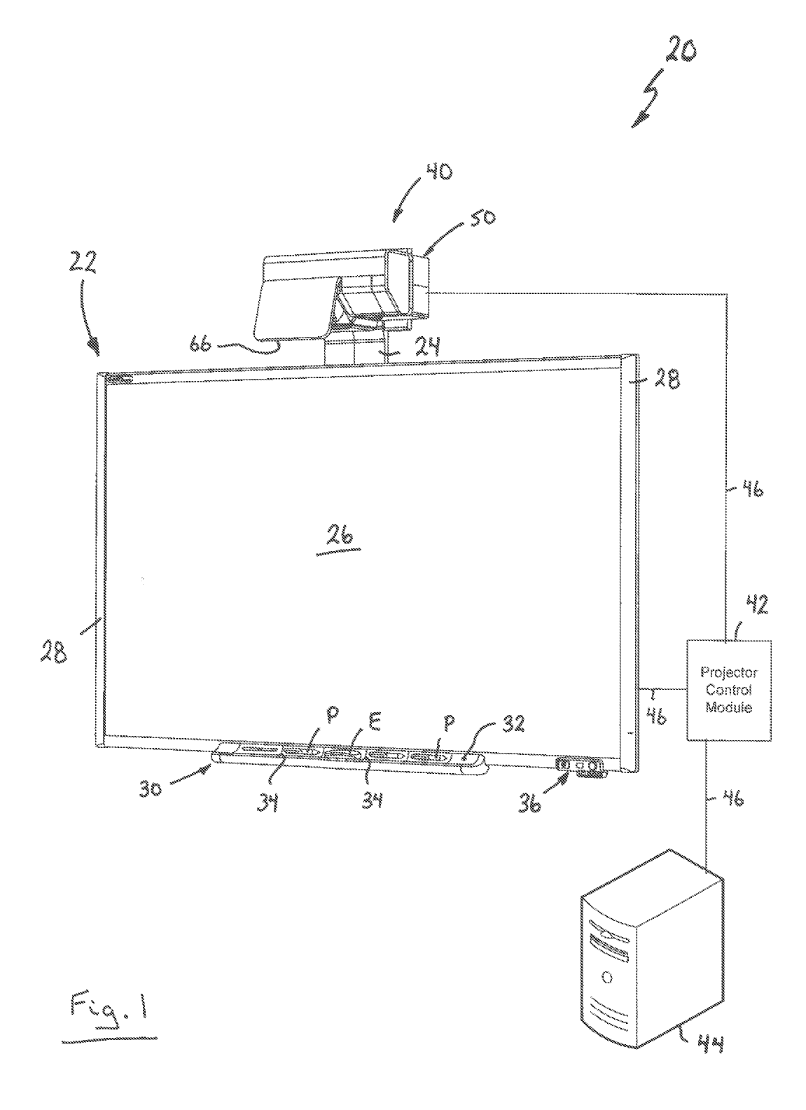

Turning now to FIG. 1, an interactive input system is shown and is generally identified by reference numeral 20. Interactive input system 20 allows a user to inject input such as digital ink, mouse events, commands, etc. into an executing application program. In this embodiment, interactive input system 20 comprises a two-dimensional (2D) interactive device in the form of an interactive board 22 mounted on a vertical support surface such as for example, a wall surface or the like via a mount 24. The interactive board 22 comprises an interactive surface 26 surrounded about its periphery by a bezel 28. A tool tray 30 is affixed to the interactive board 22 adjacent the bottom segment of the bezel 28 via suitable fasteners (not shown) and has an upper surface 32 configured to define a plurality of receptacles or slots 34. The receptacles 34 are sized to receive one or more pen tools P as well as an eraser tool E. Control buttons 36 are also provided adjacent one end of the bottom segment of the bezel 28 to enable a user to control operation of the interactive board 22. An interactive projector 40 is mounted on the support surface above the interactive board 22 via mount 24 and projects an image onto the interactive surface 26 of the interactive board 22. A projector control module 42 is mounted on the wall surface to one side of the interactive board 22 and communicates with the interactive board 22, the interactive projector 40 and a general purpose computing device 44 over wired communication links 46 such as for example universal serial bus (USB) connections.

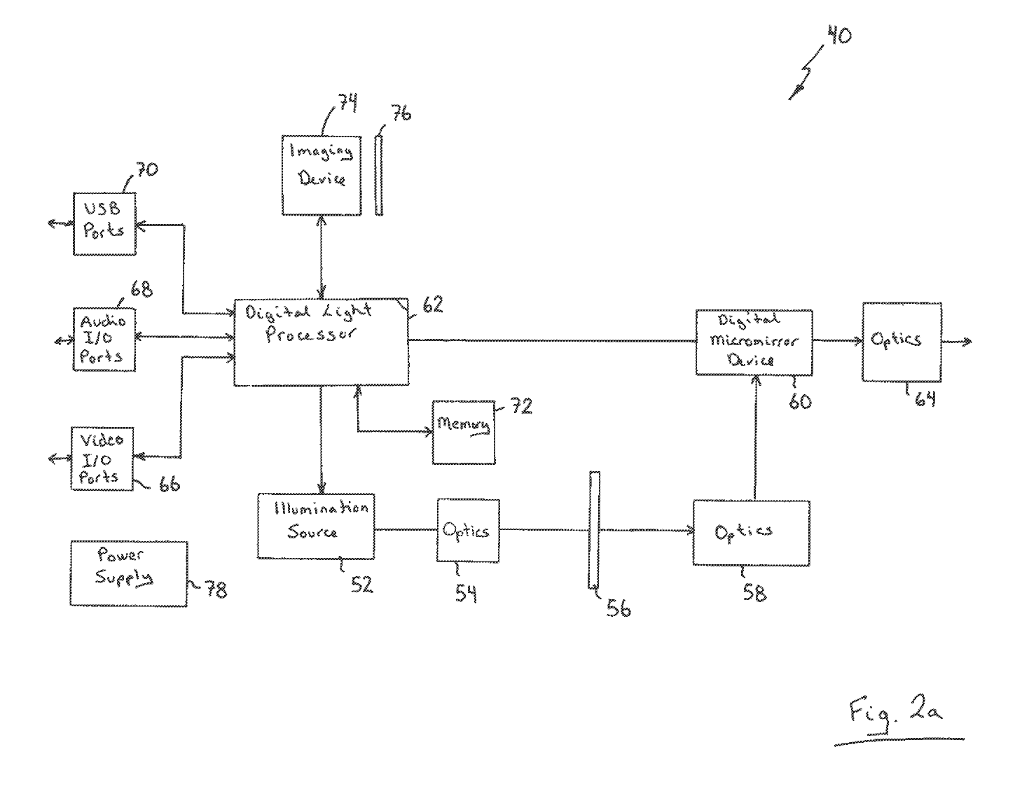

Looking at FIGS. 1 and 2a, the interactive projector 40 will now be further described. In this embodiment, the interactive projector 40 employs digital light processing (DLP) technology. As can be seen, the interactive projector 40 comprises a housing 50 that accommodates an illumination source 52 such as for example an ultra-high performance (UHP) lamp. Light output by the illumination source 52 is directed towards optics 54 in the form of a condensing lens 54. Light exiting the optics 54 passes through a rotating colour wheel 56 and impinges on optics 58 in the form of a shaping lens. Light exiting the optics 58 impinges on a digital micromirror device 60 that is controlled by a digital light processor 62 allowing an image to be created. The image created by the digital micromirror device 60 is in turn directed to optics 64 in the form of a projecting lens. From the optics 64, the image is projected onto a mirror 66 and reflected by the mirror 66 onto the interactive surface 26 of the interactive board 22.

The digital light processor 62 is also connected to video and audio input/output (I/O) ports 66 and 68, respectively, USB ports 70 and memory 72. The video and audio I/O ports 66 and 68 may comprise for example an HDMI port, an Ethernet port, an RS232 port, an S-video port, a composite video port, stereo audio ports etc. An imaging device 74 in the form of a digital camera is mounted on the housing 50 and has a field of view that looks through an infrared (IR) bandpass filter 76 onto the interactive surface 26 of the interactive board 22. As a result, only IR light impinges on the imaging sensor of the imaging device 74. Imaging device 74 also communicates with the digital light processor 62. A power supply 78 connectable to an AC mains power source provides the operating power to the various components of the interactive projector 40. In this embodiment, the interactive projector is an ultra-short throw projector and may be of the type such as that manufactured by Seiko Epson Corporation of Japan under the name BrightLink 455Wi.

During operation with the interactive projector 40 powered on, the illumination source 52 emits light that has been condensed and shaped by the optics 54 and 56 and that has passed through the rotating colour wheel 56 before impinging on the digital micromirror device 60. The digital light processor 62, which receives image data output by the general purpose computing device 44 via the projector control module 42 and USB connections 46, controls the digital micromirror device 60 so that a corresponding image is created by the digital micromirror device 60 when illuminated. The created image is projected by the optics 64 onto the mirror 66 and reflected resulting in the image being projected onto the interactive surface 26. As this occurs, the imaging device 74 acquires image frames at its set frame rate and conveys the acquired image frames to the digital light processor 62. The digital light processor 62 in turn processes captured image frames to determine whether an active pen tool P exists therein and if so, to determine the position of the active pen tool P in X-Y coordinates relative to the interactive surface 26. The digital light processor 62 in turn conveys the active pen tool coordinates (X_{Active Pen Tool}, Y_{Active Pen Tool}) to the projector control module 42 via the USB connection 46. As will be appreciated, while an active pen tool P appears in captured image forms, the interactive projector 40 provides an X-Y coordinate stream to the projector control module 42.

When a passive pointer such as a passive pen tool or a user's finger is brought into the field of view of the imaging device 74, since the field of view of the imaging device 74 looks through the IR bandpass filter 76, the passive pointer does not appear in the captured image frames. When an active pen tool P, having an infrared light source that is illuminated, is brought into the field of view of the imaging device 74, the IR light emitted by the active pen tool P passes through the bandpass filter 76 and impinges on the imaging sensor of the imaging device 74. As a result, the active pen tool P appears as a bright spot on a dark background in the image frames captured by the imaging device 74. As shown in FIG. 2b, in this embodiment, the active pen tool P comprises a housing body 80 accommodating an IR light source 82 such as one or more IR light emitting diodes adjacent its tip 84. An actuator 86 is also accommodated by the body 80 adjacent tip 84 and is operatively associated with a switch 88 that is actuable to connect a power source 90 in the form of one or more batteries to the IR light source 82. When the active pen tool P is brought into contact with the interactive surface 26 with sufficient force, the actuator 86 causes switch 88 to close resulting in the IR light source 82 being connected to the power source 90 and illuminating.

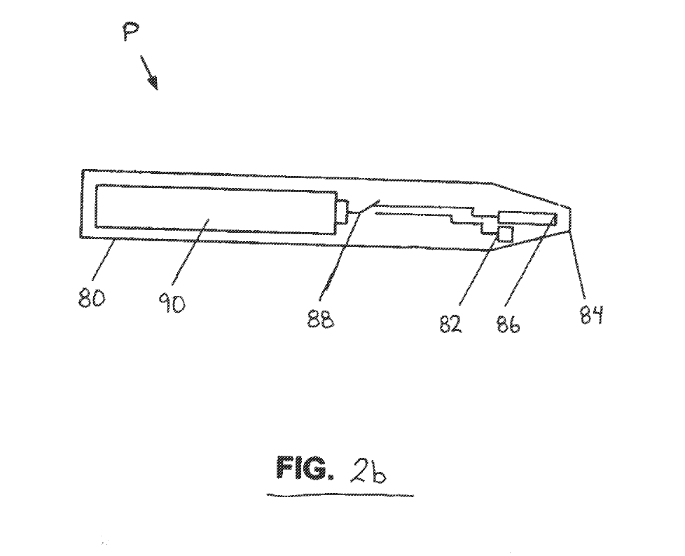

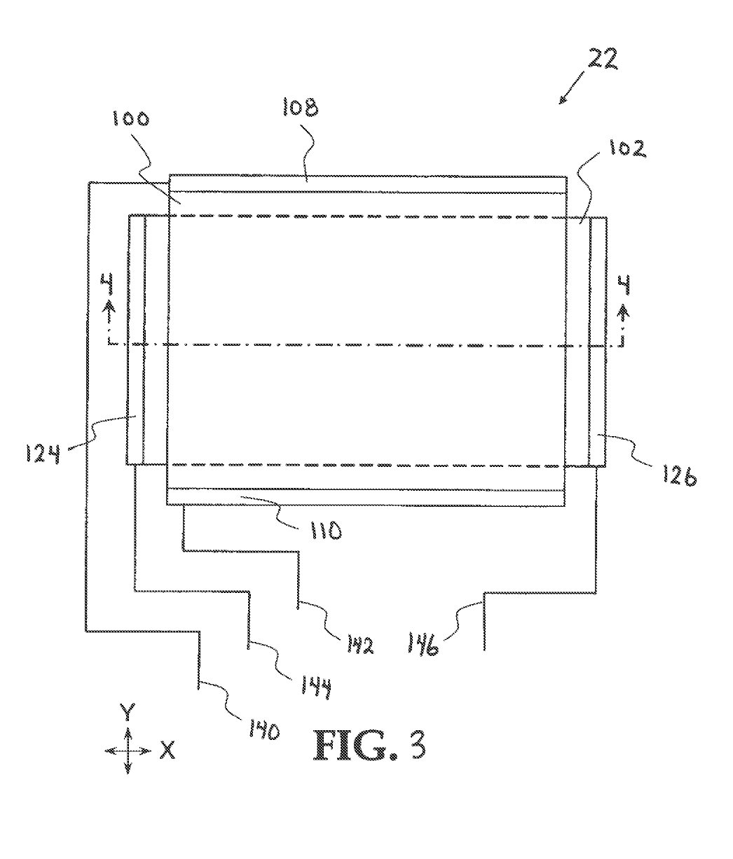

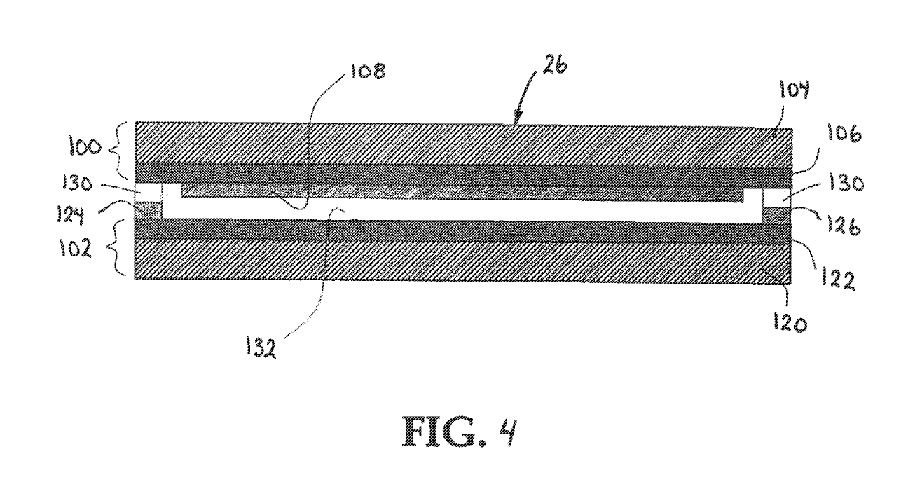

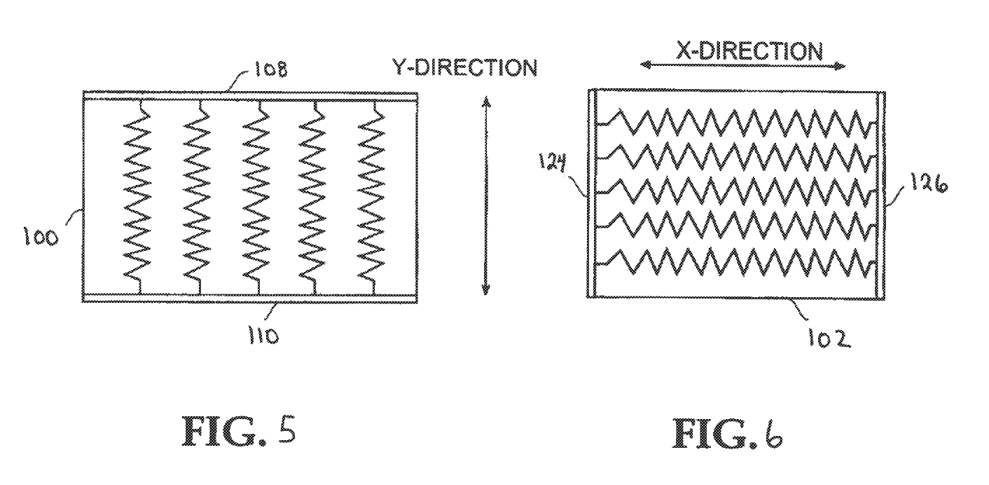

Turning now to FIGS. 3 to 7, the componentry of the interactive board 22 is better illustrated. As can be seen, the interactive board 22 comprises generally rectangular top structure 100 disposed over generally rectangular rectangular bottom structure 102. The top structure 100 defines interactive surface 26 and comprises an upper, flexible continuous layer or sheet 104 formed of polyester or other suitable material and a rectangular resistive layer or film 106 sputtered on or otherwise applied to one side of the sheet 104. In this embodiment, the resistive film 106 is formed of indium tin oxide (ITO) and defines a continuous resistive sheet. The resistive film 106 typically has a resistance in the range of from about 60 ohms to about 500 ohms. Bus bars 108 and 110 extend along the upper and lower sides of the top structure 100 and are electrically connected to the resistive film 106. The bus bars 108 and 110 in this embodiment are formed of silver-particle filled polymer, thick film conductive ink.

The bottom structure 102 comprises a substrate 120 formed of polyester or other suitable material and a rectangular resistive layer or film 122 sputtered on or otherwise applied to one side of the substrate 120. The resistive film 122 is also formed of indium tin oxide (ITO) and defines a continuous resistive sheet. The resistive films 106 and 122 are of generally uniform resistivity. Bus bars 124 and 126 extend along the left and right sides of the bottom structure 102. The bus bars 124 and 126 are also formed of silver-particle filled polymer, thick film conductive ink. The conductive ink forming the bus bars 108, 110, 124 and 126 is selected to exhibit a conductivity that is about 1000 times greater than the conductivity of the ITO resistive films 106 and 122.

A spacer 130 formed of adhesive acts between the top and bottom structures 100 and 102 adjacent their peripheral edges to secure the top and bottom structures together while maintaining an air gap 132 between the top and bottom structures. Conductors 140 and 142 extend from the bus bars 108 and 110 and lead to well known decoding circuitry (not shown) such as that described in U.S. Pat. No. 6,246,394 to Kalthoff et al. Conductors 144 and 146 extend from the bus bars 124 and 126 and also lead to well known decoding circuitry (not shown).

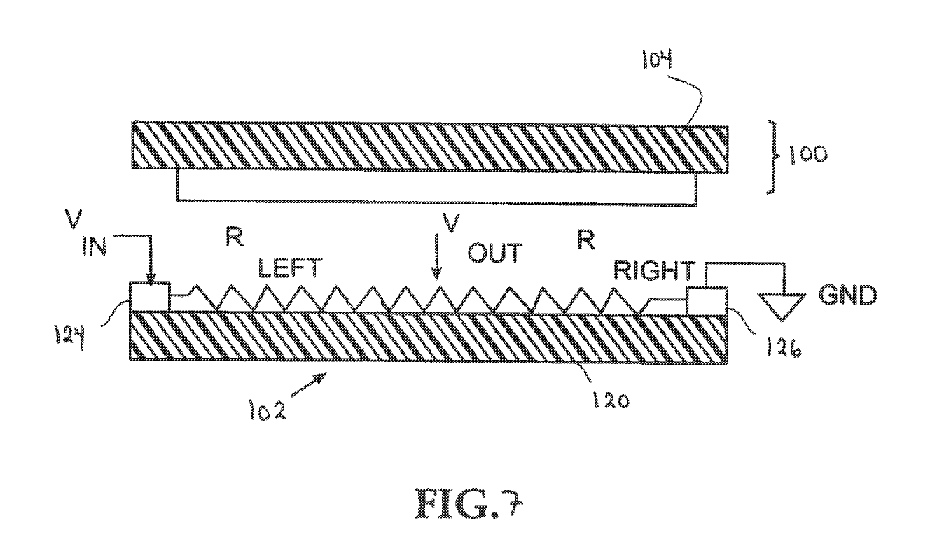

During operation of the interactive board 22, a voltage gradient Vin is initially applied across one of the top and bottom structures 100 and 102, in this example, the bottom structure 102. In particular, a voltage source is connected to the bus bar 124 while the bus bar 126 is connected to ground as shown in FIG. 7 resulting in a voltage gradient in the X-direction being developed across the ITO resistive film 122. When a pointer is brought into contact with the interactive surface 26 with sufficient activation force to bring the top and bottom structures 100 and 102 together, the ITO resistive film 106, adjacent the contact point, contacts the ITO resistive film 122. The point of contact is represented by the vertical arrow marked Vout.

The resistance of the ITO resistive film 122 between the point of contact Vout and the bus bar 126 is represented by Rright, and the resistance of the ITO resistive film 122 between the point of contact Vout and the bus bar 124 is represented by Rleft. The ratio of the voltage measured between the point of contact Vout and the grounded bus bar 126 to the voltage gradient Vin is equal to the ratio of the resistance Rright to the total resistance Rright+Rleft. Thus, the top and bottom structures 100 and 102 act as a voltage divider circuit. The decoding circuitry that is electrically connected to the bus bars 108 and 110 via the conductors 140 and 142 probes the ITO resistive film 106 and generates a resultant value that represents the X-coordinate of the contact point Vout on the interactive surface 26 of the interactive board 22 as a result of the contact of ITO resistive film 106 with the biased ITO resistive film 122.

With the X-coordinate known, the voltage gradient Vin is applied across the top structure 100 by connecting the voltage source to the bus bar 108 and connecting the bus bar 110 to ground. This results in a voltage gradient in the Y-direction being developed across the ITO resistive film 106. The decoding circuitry that is electrically connected to the bus bars 124 and 126 via the conductors 144 and 146 probes the ITO resistive film 122 and generates a resultant value that represents the Y-coordinate of the contact point Vout on the interactive surface 26 of the interactive board 22 as a result of the contact of ITO resistive film 122 with the biased ITO resistive film 106. The X-Y coordinates are in turn output by the interactive board 22 and conveyed to the projector control module 42 via the USB connection 46. As will be appreciated, while a pointer control on the interactive surface 26 with sufficient force exits, the interactive board 22 provides an X-Y coordinate stream to the projection control module 42.

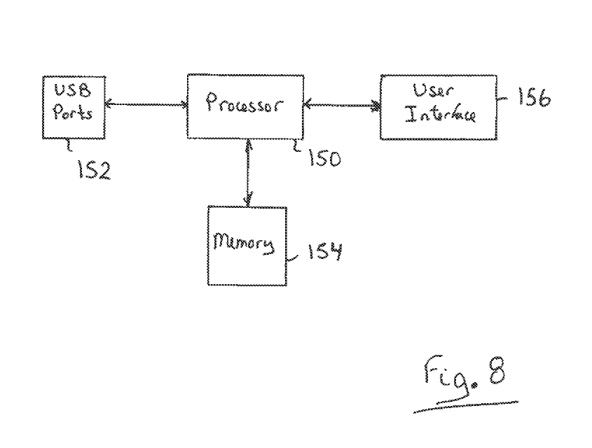

Turning now to FIG. 8, the projector control module 42 is better illustrated. As can be seen, the projector control module 42 comprises a processor 150 that is connected to USB ports 152, memory 154 and user interface 156. The memory 154 stores X-Y coordinate streams received from one or both of the interactive board 22 and interactive projector 40. The memory 154 also stores a pointer event processing routine that is executed by the processor 150 allowing the processor 150 to differentiate between passive and active pointer contacts made on the interactive surface 26 and to output the X-Y coordinates corresponding to the pointe contacts to the general purpose computing device 44 via USB connection 46. User interface 156 may comprise a touch screen and/or one or more physical buttons to allow a user to input commands to the processor 150 in order to control the interactive projector 40.

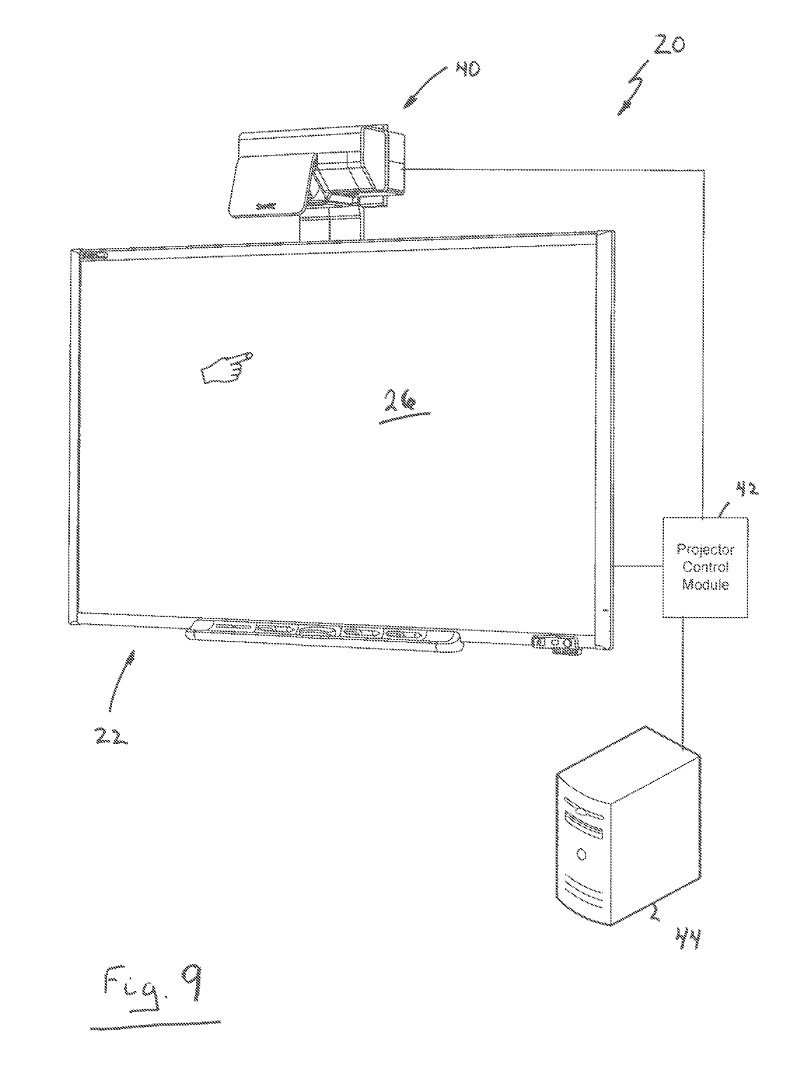

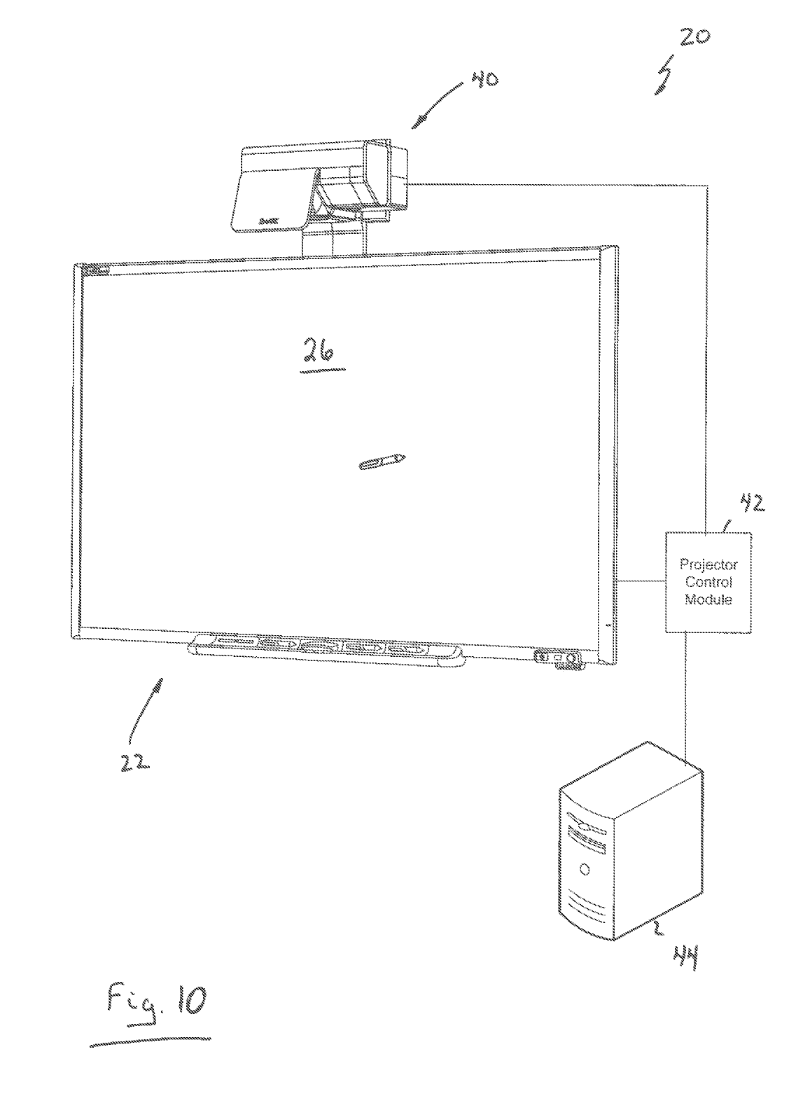

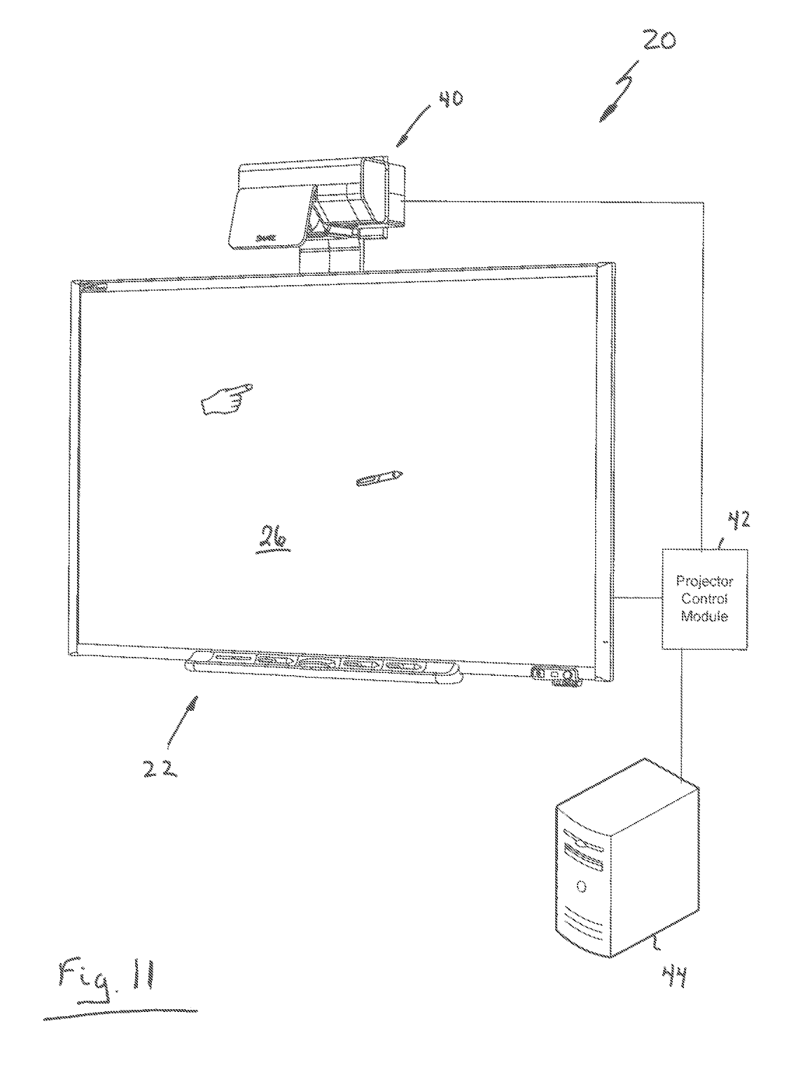

During execution of the pointer event processing routine, the processor 150 of the projector control module 42 examines the X-Y coordinate stream input to determine if X-Y coordinates are received from both the interactive board 22 and the interactive projector 40. If the interactive board 22 outputs X-Y coordinates and the interactive projector 40 does not output X-Y coordinates, signifying that the interactive projector 40 could not see the pointer brought into contact with the interactive surface 26, the X-Y coordinates are deemed to be generated as a result of a passive pointer brought into contact with the interactive surface 26 such as a finger as shown in FIG. 9 or a passive pen tool (not shown). A passive pointer write event comprising the X-Y coordinates is in turn generated by the processor 150 and is conveyed to the general purpose computing device 44 via the USB connection 46. If both the interactive board 22 and the interactive projector 40 output X-Y coordinates, the X-Y coordinates are compared. If the X-Y coordinates are substantially coincident, the X-Y coordinates are deemed to be generated as a result of an active pen tool P brought into contact with the interactive surface 26 as shown in FIG. 10. An active pointer write event comprising the X-Y coordinates is in turn generated by the processor 150 and is conveyed to the general purpose computing device 44 via the USB connection 46. If however, the X-Y coordinates are not substantially coincident, the X-Y coordinates are deemed to be generated as a result of simultaneous passive pointer and active pen tool contacts with the interactive surface 26 as shown in FIG. 11. In this scenario, the X-Y coordinates output by the interactive projector 40 represent the actual active pen tool coordinates relative to the interactive surface 26. The X-Y coordinates output by the interactive board 22 represent the average of the passive pointer and active pen tool coordinates. The X-Y coordinates of the passive pointer relative to the interactive surface 26 can however be approximated from the known active pen tool coordinates and the average coordinates according to:

X_{Passive Pointer}=2X_{average}−X_{Active Pen Tool}

Y_{Passive Pointer}=2Y_{average}−Y_{Active Pen Tool}

As will be appreciated, in this scenario, the calculated passive pointer coordinates are not as accurate as in the single passive pointer touch scenario but are sufficiently accurate for gesture input. In this embodiment, passive pointer and active pointer write events for both the passive pointer and active pen tool contacts are generated and are conveyed to the general purpose computing device 44 via the USB connection 46.

The general purpose computing device 44 in this embodiment is a personal computer or other suitable processing device or structure comprising, for example, a processing unit comprising one or more processors, system memory (volatile and/or non-volatile memory), other non-removable or removable memory (e.g. a hard disk drive, RAM, ROM, EEPROM, CD-ROM, DVD, flash memory, etc.) and a system bus coupling the various computing device components to the processing unit. The general purpose computing device 44 may also comprise networking capabilities using Ethernet, WiFi, and/or other network formats, to enable access to shared or remote drives, one or more networked computers, or other networked devices.

The general purpose computing device 44 executes one or more application programs and provides image data such as its desktop to the projector control module 42 that is in turn conveyed to the interactive projector 40. The general purpose computing device 44 in response to write events received from the projector control module 42 records the write events as writing or drawing (i.e. digital ink) and updates the image data output to the interactive projector 40 via the projector control module 42, if required, so that the image presented on the interactive surface 26 reflects pointer interaction therewith.

In the exemplary embodiment described above, the processor 150 is configured to generate write events when X-Y coordinate streams are received from one or both of the interactive board 22 and interactive projector 40. If, however, it is desired to have the processor 150 generate mouse events in response to one or multiple X-Y coordinate streams, a software setting can be adjusted by a user so that X-Y coordinate streams resulting from passive and/or active pointer contacts with the interactive surface 26 are treated as mouse events. In this case, when the processor 150 generates mouse events that are conveyed to the general purpose computing device 44, the general purpose computing device 44 uses the mouse events to control execution of an application program and updates the image data output to the interactive projector 40 via the projection control module 42, if required.

Alternatively, X-Y coordinate streams received from the interactive board 22 and interactive projector 40 may be treated differently. For example, the X-Y coordinate streams received from the interactive projector 40 as a result of active pointer contact made on the interactive surface 26 may be used by the processor 150 to generate write events and the X-Y coordinate streams received from the interactive board 22 as a result of passive pointer contacts made on the interactive surface 26 may be used by the processor 150 to generate mouse events or vice versa.

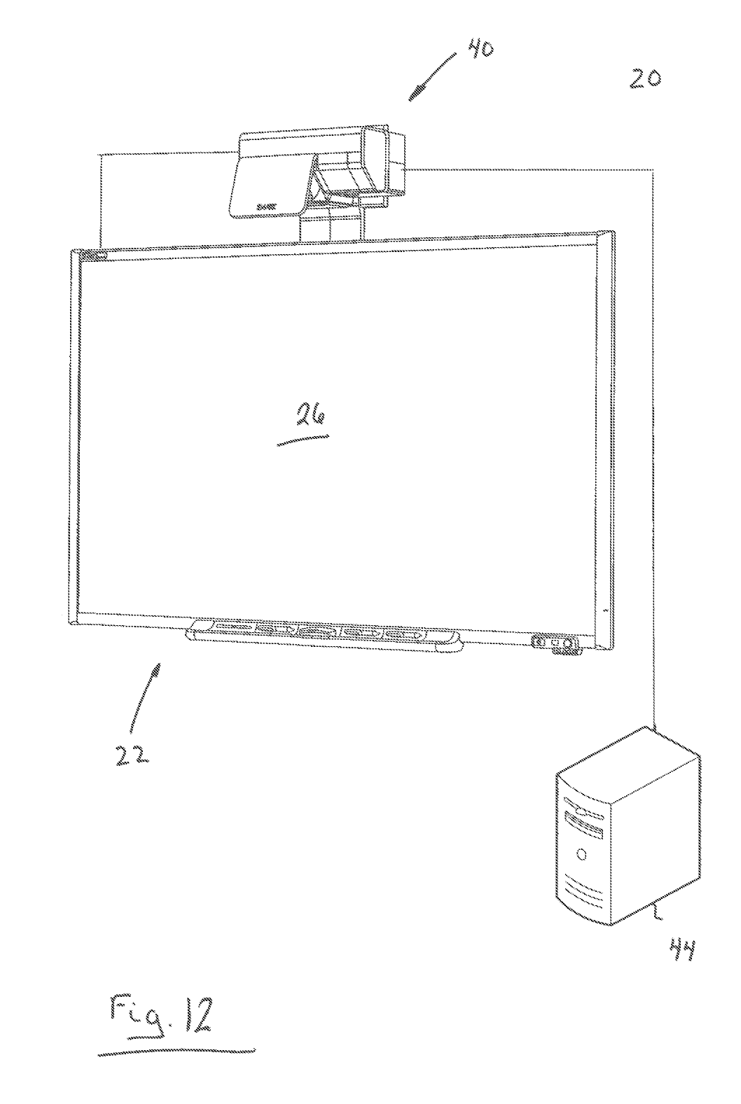

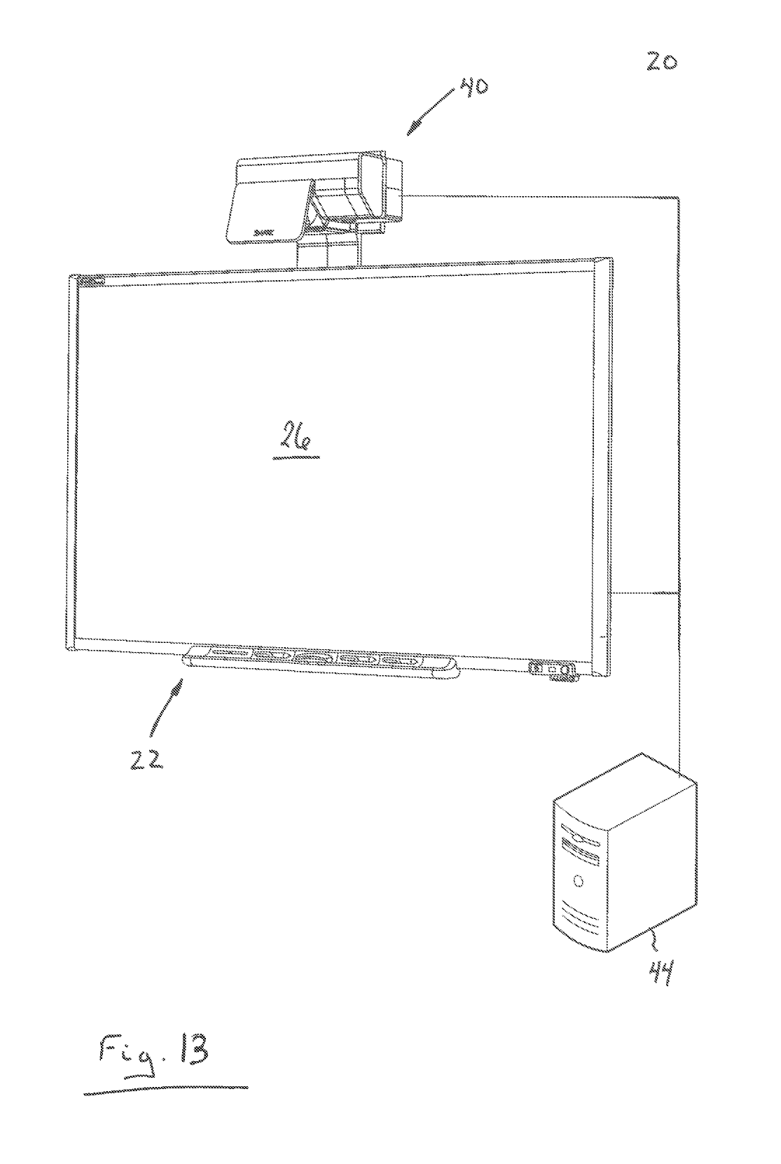

In the embodiment described above, the X-Y coordinates output by the interactive board 22 and the X-Y coordinates output by the interactive projector 40 are conveyed to the projector control module 42 which in turn processes the received X-Y coordinates and generates the appropriate output event for conveyance to the general purpose computing device 44. If desired, the projector control module can be omitted. For example, in the embodiment shown in FIG. 12, the X-Y coordinates output by the interactive board 22 are conveyed directly to the interactive projector 40 over a suitable wired connection such as a USB connection. In this case, the digital light processor 62 of the interactive projector 40 executes the pointer event processing routine and generates the appropriate output events for conveyance directly to the general purpose computing device 44 over a suitable wired connection such as a USB connection. In yet another embodiment, as shown in FIG. 13, the general purpose computing device 44 executes the pointer event processing routine and receives the X-Y coordinates output by the interactive board 22 and the interactive projector 40 directly over suitable wired connections such as USB connections.

In the exemplary embodiments described above, the digital light processor 42 processes the image frames. If desired, the image frames captured by the imaging device 74 may be processed by a separate processor such as an onboard embedded imaging device processor. Also, in the embodiment of FIG. 13, a separate processor may be employed in the interactive projector 40 to execute the pointer event processing routine.

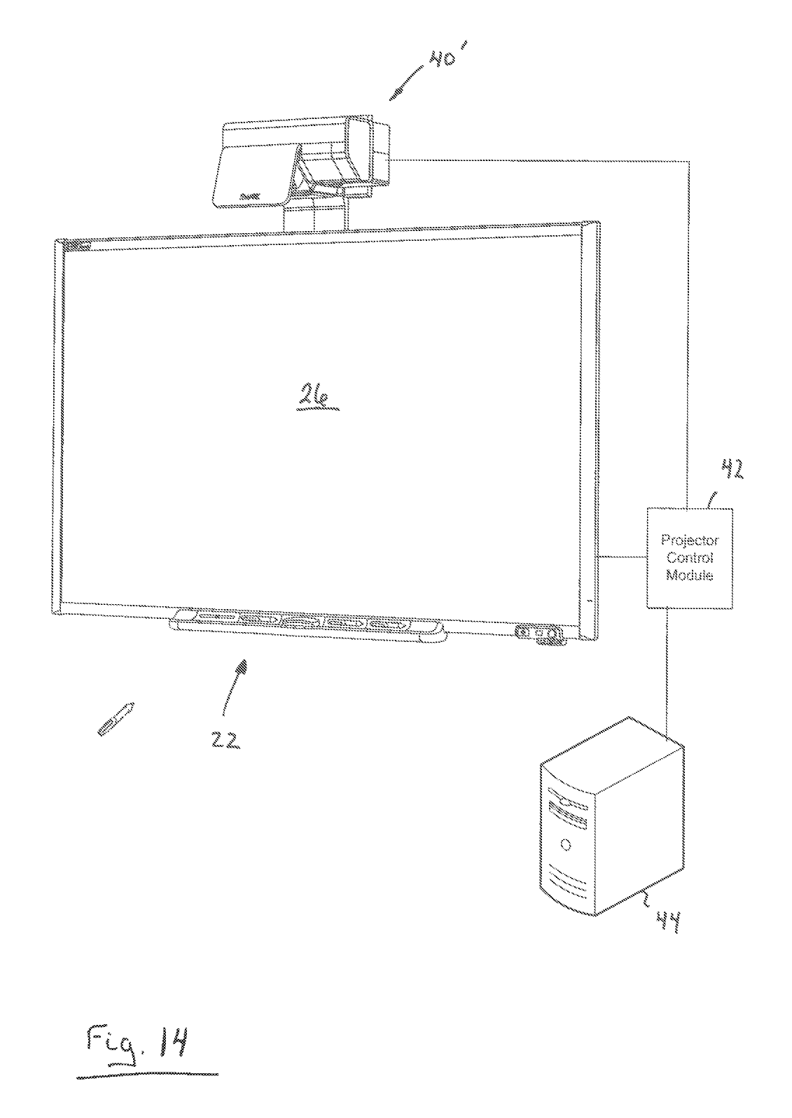

The interactive input system 20 can also be used with other types of interactive projectors. Turning now to FIG. 14, an interactive input system similar to that of FIG. 1 is illustrated. In this embodiment however, the interactive projector 40′ is of the type sold by Texas Instruments Incorporated of Dallas, Tex. under the name PointBlank™ or of the type sold by SMART Technologies ULC of Calgary, Alberta under the name LightRaise™ 40wi. The interactive projector 40′ does not comprise an imaging device but rather comprises an infrared light source that projects an IR light pattern or grid on the interactive surface 26. The interactive projector 40 is used in conjunction with an active pen tool having a camera adjacent its tip that is spaced from the interactive surface 26 when the active pen tool is brought into contact with the interactive surface, to allow image frames comprising the IR pattern or grid to be captured by the camera. A processor in the active pen tool processes the captured image frames to determine the location of the active pen tool tip relative to the IR pattern and hence the X-Y coordinates of the active pen tool relative to the interactive surface 26. The active pen tool in turn communicates the X-Y coordinates to the interactive projector 40′ wirelessly, which in turn conveys the X-Y coordinates to the projector control module 42 for processing in the manner described above.

In this embodiment, as the active pen tool comprises a camera, the camera is able to image the IR pattern projected on the interactive surface 26 from a distance and therefore is able to act as a remote pointer.

The interactive board 22 and interactive projector 40 may be calibrated using a method such as that described in U.S. Pat. No. 7,289,113 to Martin, assigned to SMART Technologies ULC, to compensate for keystoning caused by misalignment between the interactive projector 40 and the interactive board 22.

In the exemplary embodiments described above, the interactive board 22 and interactive projector 40 are mounted on the support surface via the common mount 24. Those of skill in the art will appreciate that the interactive board 22 and interactive projector 40 may be separately mounted on the support surface.

Although exemplary interactive projectors are described above, those of skill in the art will appreciate that other interactive projectors may be employed. Depending on the interactive projector configuration, the interactive projector may be mounted on the same support surface as the interactive board or may be mounted on a different wall or ceiling surface. The interactive board 22 need not be mounted on the support surface. The interactive board may alternatively be suspended or otherwise supported in an upright manner.

Although the interactive input systems have been described as comprising an interactive board that employs analog resistive technology to detect pointer contacts, those of skill in the art will appreciate that interactive boards employing other types of technologies to register pointer input may be used. For example, interactive boards employing electromagnetic, capacitive, acoustic or other suitable technologies to register pointer contacts may be used.

Also, although the interactive board, interactive projector, projector control module and general purpose computing device have been described as communicating over wired USB connections, those of skill in the art will appreciate that these components may communicate over other types of suitable wired or wireless connections.

Although embodiments have been described and illustrated, those of skill in the art will appreciate that other variations and modifications may be made without departing from the scope thereof as defined by the appended claims.

What is claimed is:

1. An interactive input system comprising:
an interactive board configured to generate positional output in response to pointer contact with an input surface thereof;
an interactive projector configured to project an image on said input surface and to capture image frames of a region of interest at least comprising said input surface; and
processing structure configured to process positional output generated by said interactive board and image data acquired by said interactive projector to determine passive and active pointer contacts on said input surface.

2. The interactive input system of claim 1 wherein said processing structure determines passive pointer contact on said input surface when said interactive board generates positional output and captured image frames are devoid of an active pointer.

3. The interactive input system of claim 1 wherein said processing structure determines active pointer contact on said input surface when said interactive board generates positional output and captured image frames comprise an active pointer.

4. The interactive input system of claim 2 wherein said processing structure determines active pointer contact on said input surface when said interactive board generates positional output and captured image frames comprise an active pointer.

5. The interactive input system of claim 1 wherein said processing structure is further configured to process captured image frames and generate positional output when an active pointer exists therein and compare the positional output with the positional output generated by the interactive board to differentiate between passive and active pointer contact on the input surface.

6. The interactive input system of claim 5 wherein the positional output generated by the processing structure and the positional output generated by the interactive board comprise X-Y coordinate streams.

7. The interactive input system of claim 6 wherein said processing structure compares the X-Y coordinate streams to determine if X-Y coordinates of said X-Y coordinate streams are generally coincident and if so, determine active pointer contact with said input surface.

8. The interactive input system of claim 7 wherein if X-Y coordinates of said X-Y coordinate streams are not generally coincident, the processing structure determines both active and passive pointer contacts with said input surface.

9. The interactive input system of claim 8 wherein said processing structure, when both active and passive pointer contacts with said input surface are determined, processes the X-Y coordinate streams to determine the X-Y coordinates of the active and passive pointer contacts.

10. The interactive input system of claim 6 wherein said processing structure comprises at least one processor of said interactive projector, said at least one processor processing captured image frames to determine the existence of an active pointer therein and the position of the active pointer in X-Y coordinates relative to the input surface.

11. The interactive input system of claim 10 wherein said processing structure further comprises at least one processor of a control module, said at least one processor of the control module comparing the X-Y coordinate streams from said interactive board and interactive projector to determine if X-Y coordinates of said X-Y coordinate streams are generally coincident and if so, determine active pointer contact with said input surface.

12. The interactive input system of claim 11 wherein if X-Y coordinates of said X-Y coordinate streams are not generally coincident, said at least one processor of the control module determines both active and passive pointer contacts with said input surface.

13. The interactive input system of claim 12 wherein said at least one processor of the control module, when both active and passive pointer contacts with said input surface are determined, processes the X-Y coordinate streams to determine the X-Y coordinates of the active and passive pointer contacts.

14. The interactive input system of claim 11 wherein said control module further comprises a user interface configured to accept user entered interactive projector control commands.

15. The interactive input system of claim 10 wherein said at least one processor of the interactive projector receives the X-Y coordinate stream from the interactive board and compares the X-Y coordinate streams to determine if X-Y coordinates of said X-Y coordinate streams are generally coincident and if so, determine active pointer contact with said input surface.

16. The interactive input system of claim 15 wherein if X-Y coordinates of said X-Y coordinate streams are not generally coincident, said at least one processor of the interactive projector determines both active and passive pointer contacts with said input surface.

17. The interactive input system of claim 16 wherein said at least one processor of the interactive projector, when both active and passive pointer contacts with said input surface are determined, processes the X-Y coordinate streams to determine the X-Y coordinates of the active and passive pointer contacts.

18. The interactive input system of claim 10 wherein said processing structure further comprises a general purpose computing device, said general purpose computing device receiving the X-Y coordinate streams from the interactive board and interactive projector, comparing the X-Y coordinate streams to determine if X-Y coordinates of said X-Y coordinate streams are generally coincident and if so, determine active pointer contact with said input surface.

19. The interactive input system of claim 18 wherein if X-Y coordinates of said X-Y coordinate streams are not generally coincident, said general purpose computing device determines both active and passive pointer contacts with said input surface.

20. The interactive input system of claim 19 wherein said general purpose computing device, when both active and passive pointer contacts with said input surface are determined, processes the X-Y coordinate streams to determine the X-Y coordinates of the active and passive pointer contacts.

21. The interactive input system of claim 1 wherein said interactive board employs one of analog resistive, capacitive, acoustic and electromagnetic pointer contact detection technology.

22. The interactive input system of claim 1 wherein said processing structure provides image data to said interactive projector, said interactive projector using said image data to project said image.

23. The interactive input system of claim 22 wherein said image is a computer desktop.

24. The interactive input system of claim 23 wherein said processing structure updates the image data provided to said interactive projector in response to determined passive and active pointer contacts.

25. The interactive input system of claim 24 wherein the image data is updated so that said image includes digital ink corresponding to the determined passive and active pointer contacts.

26. A method comprising:
receiving, by processing structure, at least one of an X-Y coordinate stream from an interactive board and an X-Y coordinate stream from an interactive projector;
when X-Y coordinate streams are received from both the interactive board and interactive projector, comparing, by the processing structure, the X-Y coordinate streams to determine if the X-Y coordinates thereof are generally coincident;
when the X-Y coordinates are generally coincident, determining, by the processing structure, that an active pointer contact with an input surface of the interactive board has been made; and
when the X-Y coordinates are not generally coincident, determining, by the processing structure, that both passive and active pointer contacts with the input surface have been made.

27. The method of claim 26 further comprising generating an event for each determined pointer contact.

28. The method of claim 27 wherein each event is one of a write event and a mouse event.

29. The method of claim 29 further comprising updating an image projected on the input surface in response to generated events.

30. A non-transitory computer readable medium embodying program instructions, which when executed by processing structure, cause the processing structure to carry out the method of claim 26.
